(19) United States
(12) Patent Application Publication
(10) Pub. No.: US 2012/0210336 A1
(43) Pub. Date: Aug. 16, 2012

(54) METHODS FOR FILTERING DEVICE ACCESS BY SESSIONS

(76) Inventor: Anatoly Greenblatt, Netanya (IL)

(21) Appl. No.: 13/396,853

(22) Filed: Feb. 15, 2012

Related U.S. Application Data
(60) Provisional application No. 61/442,949, filed on Feb. 15, 2011.

(51) Int. Cl. G06F 9/46

(52) U.S. Cl. 719/321

(57) ABSTRACT

The creation of individual workstations is enabled by filtering device communications such that device functions are visible to only the workstations to which each device is assigned. Device filtering is done through the use of operating system components providing full device functionality and performance without the creation of special device drivers or routing of communications through virtual machines or networks.

### FIELD OF THE INVENTION

Embodiments of the present invention are generally related to methods and systems for allowing the assignment of devices to individual sessions. More specifically, the present invention is related to methods that allow the utilization of devices directly or indirectly connected to a single computer within a subset of the sessions executing on the computer.

### BACKGROUND

Implementation of multiple workstation systems on single computer requires the association of devices such as keyboards, mice, displays, speakers, microphones with one or more workstations. By associating devices to workstations the user has the same working environment as with a personal computer (PC) used by a single user. Normally, the applications and operating environment of each workstation can be implemented using the normal operating system capabilities.

Workstations may be implemented in a number of ways. One common method of implementing workstations is to use the ability of the operating system to create multiple sessions where each session has its own interface to devices and applications. This method is used by SoftXpand, Aster, and Windows Multipoint Server. Another method is to use a virtual machine for each workstation. This provides not only a separate interface to devices and applications, but also provides an emulation of complete computers. Virtual machines, such as VMWare and Oracle VirtualBox provide more complete isolation of each workstation at the added expense of duplication of components such as the operating system and emulation of a limited set of devices and device functionality. Virtual Machines are commonly used on centralized server systems with thin clients providing access to the virtual machines running on a server. A third approach is to use an application that appears to be the operating system's user interface. This approach is most commonly seen on desktop portability products such as Migo or MojoPac. All these approaches share a common need to control workstation access to devices when multiple workstations are executing on a single computer with connected devices.

### REFERENCES

SoftXpand: MiniFrame Ltd., www.miniframe.com
Aster: IBIK, international.ibik-soft.com
Windows Multipoint Server: Microsoft Corp., http://www.microsoft.com/windows/multipoint/
VMWare Workstation: VMWare, http://www.vmware.com/products/workstation/overview.html
VirtualBox: Oracle, https://www.virtualbox.org/

### SUMMARY OF THE EMBODIMENTS

The invention provides methods for assigning peripheral devices to all or a subset of the sessions executing on a single computer allowing the use of the devices with the assigned sessions without interaction with sessions to which the peripheral devices are not assigned. Assignment of peripheral devices to sessions allows the use of the sessions independently in ways that emulate the use of individual computers. Peripheral device filtering also allows the rapid change in use of the peripherals with different sessions by changing the device assignments.

Association of devices to workstations as done according to exemplary embodiments of the current invention as required, when, as is normal, the operating system treats multiple devices of any given device type as equivalent. For example, in the Microsoft Windows operating systems, multiple keyboards may be used but the operating system treats a key press on any keyboard the same as the same key press on any other keyboard. Similarly, when multiple mice, touch pads or touch screens are connected to the computer the operating system normally treats all mice as equivalent and any mouse, touch pad or touch screen can be used to position the mouse cursor and/or create mouse button events (clicks, double clicks) or a combination of the two types of input (position and button) to affect such actions as drag and drop. Some embodiments of the current invention overcome the limitation of devices to one or more workstations by modifying the device control stacks to allow the devices to be accessed by only the assigned workstations. Different embodiments of the filtering mechanism are required for different device types due to the different mechanisms used by the operating system to

[symbol]

Embodiments of the current invention provides a method of limiting device operations to workstations associated with operating system sessions comprising: assigning a device to a workstation; and using a filter to allow access to only assigned devices from specified workstations.

In some embodiments the method further comprises mapping from operating system sessions to video output devices.

In some embodiments the method further comprises mapping from video device names to video output identifiers.

In some embodiments the method further comprises filtering device commands to buffered input devices.

In some embodiments filtering device commands comprises using of an upper and lower filter driver.

In some embodiments the upper filter driver allows connecting multiple sessions to the device stack.

In some embodiments the lower filter driver provides separation of received inputs into separate queues for each workstation.

In some embodiments filtering device commands allows for bypassing of device stack components by communicating commands directly between the upper and lower filter drivers.

In some embodiments the method further comprises filtering removable storage.

In some embodiments the filtering is based on using minifilters.

In some embodiments the filtering comprises using minifilters filters access to removable storage by accepting or rejecting requests to open the volumes and/or files on the removable storage.

In some embodiments the method further comprises filtering unbuffered input devices.

In some embodiments the filtering comprises using filter drivers.

In some embodiments the filter drivers filter access to unbuffered input devices by accepting or rejecting commands to open said unbuffered input devices.

In some embodiments the method further comprises filtering endpoint devices.

In some embodiments the filtering is based on the using of registry filters.

In some embodiments the registry filters filter access to the endpoint devices by

[symbol]

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

Unless marked as background or art, any information disclosed herein may be viewed as being part of the current invention or its embodiments.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments of the present invention only, and are presented in the cause of providing what is believed to be the most useful and readily understood description of the principles and conceptual aspects of embodiments of the invention. In this regard, no attempt is made to show structural details in more detail than is necessary for a fundamental understanding of the embodiments; the description taken with the drawings making apparent to those skilled in the art how the several forms of the invention may be embodied in practice. In the accompanying drawings:

FIG. 1 is a schematic illustration of the general environment of this invention.

FIG. 2 is a flowchart illustrating the process of filtering peripheral devices.

FIG. 3 are schematic illustrations of the relationship between physical devices, the logical representation of devices and registry information about devices, wherein:

FIG. 3A shows the physical devices;

FIG. 3B shows the logical representation of devices; and

FIG. 3C shows the registry information about devices.

FIG. 4A is a flowchart illustrating the process of filtering display devices.

FIG. 4B shows the flow chart 435 containing the steps taken to define an association between each video output assigned to a workstation.

FIG. 4C shows the flow chart containing the steps taken when a workstation is started to filter the video output devices.

FIG. 5 is a schematic illustration of the data relating to video devices.

FIG. 6A is a schematic illustration of the device stack for human input devices.

FIG. 6B is a schematic illustration of a device stack modified for filtering human input devices.

FIG. 7 is a flowchart illustrating the process of filtering human input devices.

FIG. 8A is a flowchart illustrating the device stack for storage devices.

FIG. 8B is a flowchart illustrating a modified device stack for filtering removable storage devices.

FIG. 9 is a schematic illustration of the filtering method for removable storage devices.

FIG. 10 is a flowchart illustrating the device stack for audio devices with enhancement for filtering audio devices.

FIG. 11 is a schematic illustration of the filtering method for audio devices.

FIG. 12A schematically shows a representation of the original unbuffered device stack.

FIG. 12B schematically shows a representation of a modified unbuffered device stack.

FIG. 13 is a schematic illustration of the filtering method for unbuffered input devices.

### DESCRIPTION OF SELECTED EMBODIMENTS

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts.

The drawings are generally not to scale. For clarity, non-essential elements were omitted from some of the drawings.

To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like.

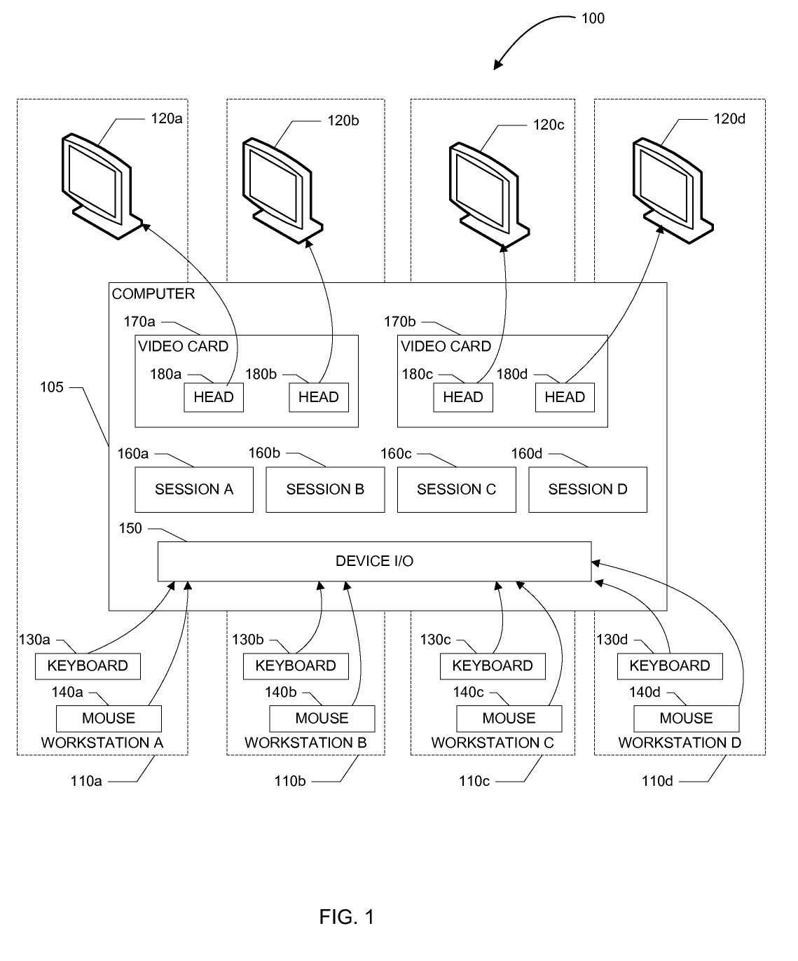

It should be understood that the various embodiments are not limited to the arrangements and instrumentality shown in the drawings. FIG. 1 shows a general representation of a computer multi-workstations system 100, using a single compute 105 according to an exemplary embodiment of the current invention.

Computer 105 is used to create four workstations (110a to 110d). From the perspective of a user, using for example the workstation 110a, the workstation 110a comprises a display (120a), keyboard (130a) and a mouse (140a). Other peripheral devices as will be described below may also be assigned to the workstation but are not shown in FIG. 1 for clarity. Other users, using for example workstations 110b to 110d are using the corresponding display (120b-d), keyboard (130a-d) and a mouse (140b-d). All keyboards (130a-d) and mice (140a-d) are connected to computer 105 and all communications from these devices are processed by the device input/output (Device I/O) 150 methods of the operating system running on the computer 105. The methods of this invention are used to filter the communications from these and other peripheral devices such that each of the software sessions (160a-d) assigned to a workstation (110a-d) interacts with the corresponding peripheral devices assigned to that workstation. Similarly, the video outputs from the sessions (160a-d) are routed by the operating system to video cards (in this exemplary embodiment, two dual-head video cards 170a-b are used for providing video signal to four displays) and through the video heads (180a-d) to the corresponding display (120a-d) assigned to the workstation.

This invention provides filtering of peripheral devices based on the configured assignment of devices to workstations. In addition embodiments of the invention provide a method of identifying the implementation of each workstation, since the operating systems normally do not implement multiple workstations on a single personal computer. For each of the workstation implementation methods listed above, it is possible to create an association of the

[symbol]

An association of a workstation and the object created to implement the workstation is required to allow the storing of the configuration information including device assignments. Workstation identities may be maintained by the system used to create and configure workstations whereas different objects will be created to implement the workstation each time the workstation is created. Workstation identifiers and association of the identifiers to the objects used to implement the workstation provides persistence between successive instantiations of the workstations.

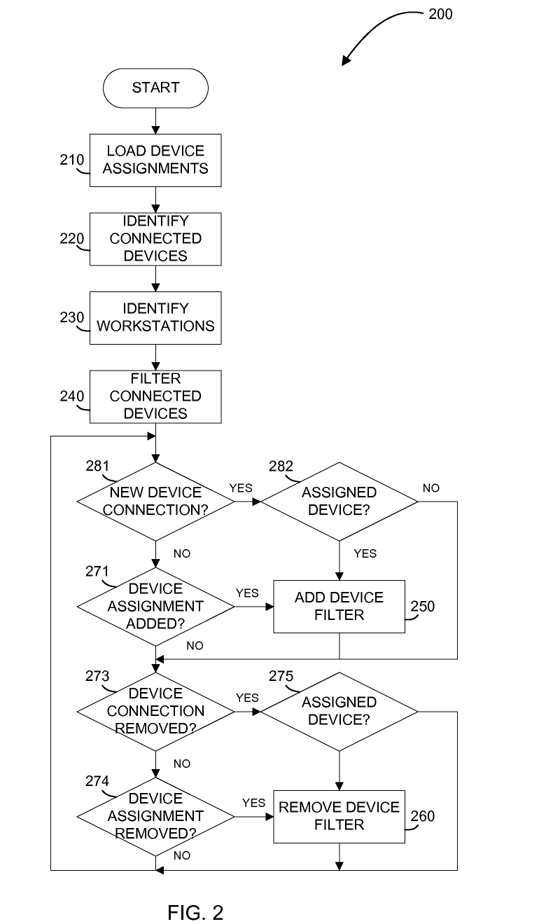

FIG. 2 presents a flow chart 200 of the general method 200 used to filter device access based on assignment of devices to workstations. This flow is started when the operating system starts or otherwise before the use of workstations to create device filters used by all the workstations. The flow chart 200 starts with the loading of device assignments 210 from a data source. The data source may be a database, file, or similar structure containing identifiers of devices and identifiers of workstations. The specific type or structure of the data source is not critical as long as it can provide pair-wise associations, also known as device mappings, between the device and workstation identifiers. The device mappings may be created manually, for example by the user indicating an association between a device selected from a list of devices and a workstation. Alternatively the device mappings may be created by applying rules to create device associations, for example by assigning one display (e.g. 120a), one keyboard (e.g. 130a) and one mouse (e.g. 140a) to each workstation (e.g. 110a). Alternatively the device mappings may be based on the method used to connect devices such as assigning all USB devices connected through a certain USB hub to a workstation when any device connected through the USB hub is assigned to a workstation. Often device assignment will be done using rules and/or connectivity to create an initial set of device mappings that are then confirmed or corrected by a user. Once created, the device associations are stored for use in step 210. The flow continues with identifying currently connected devices in step 220 and identification of workstations in step 230. Steps 210, 220 and 230 may be done in any order. Once the associations, devices and

[symbol]

Once the initial filtering has been applied it is necessary to recognize new devices and changed associations between devices and workstations. When a new device connection is recognized 281 a test 282 for assignment to each workstation is done and the filters added in step 250. Similarly, if a new association between a device and a workstation (e.g. 110a) is created (device assignment added 271) for a previously connected device the appropriate filter is added to the device in step 250.

When a device connection is removed 273 a test 275 for assignment to each workstation is done and the filters removed in step 260. Similarly, if an association between a device and a workstation (e.g. 110a) is removed (device assignment removed 274) for a previously connected device the appropriate filter is removed from the device in step 260.

Modification of device assignments may be handled by a sequence of removing the current workstation assignment in step 260 and adding a new workstation assignment for the same device in step 250.

The mechanisms used to implement access filtering will be described for specific device types below.

Video Display Devices

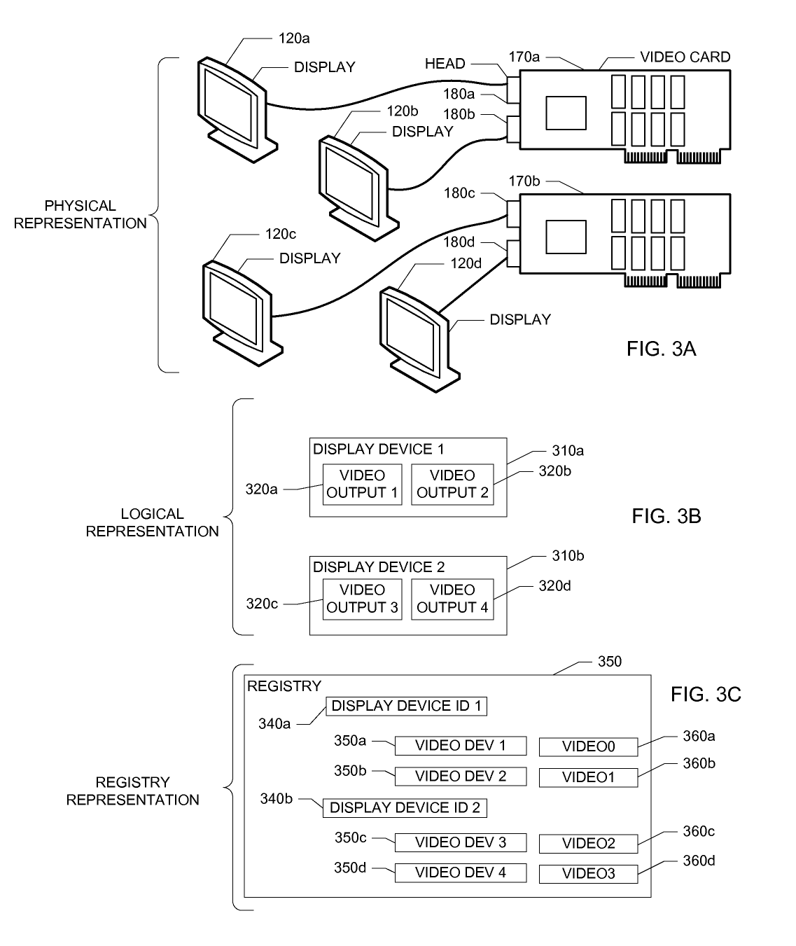

FIG. 3 presents the general structure of video display devices for comprehension of the methods used to filter video output from workstations, wherein: FIG. 3A shows the physical devices; FIG. 3B shows the logical representation of devices; and FIG. 3C shows the registry information about devices.

Generally a host computer (105) will contain one or more video cards (in the demonstrated exemplary embodiment, cards 170a and 170b) wherein each video card contain one or more output connectors commonly termed heads (180a-d) as in “single head” or “dual head” adapter. Note that other terms such as Display Adapter, Display Device or Video Adapter are commonly used to refer to the same or equivalent devices as are termed video card 170 in this invention. The video card 170 may also be provided as an integral component of a mother board or be a virtual video card that processes video display commands for transmission to a remote video display system connected to the host PC using any of several communications

[symbol]

Each output connector or head (180a-d) on a video card (170a and 170b) will be referred to as a video output for purposes of this invention. This is convenient as workstation users normally consider video output to be associated with individual monitor or other display device 120 and not with the video display adapters.

FIG. 3A shows the physical arrangement of video cards (170a and 170b), their output connectors or heads (heads 180a and 180b of video card 170a, and heads 180c and 180d of video card 170b) and displays (120a-d) connected to the video cards (170a and 170b). In this instance the host computer is represented as containing two dual head video cards allowing the concurrent connection of up to four displays.

FIG. 3B shows the logical arrangement of the same configuration whereby the operating system would represent the configuration of video cards (170a and 170b) as two Display Devices (310a and 310b) each of which contains a representation of two Outputs (320a-d) corresponding to the heads (180a-d) on the video cards (170a and b).

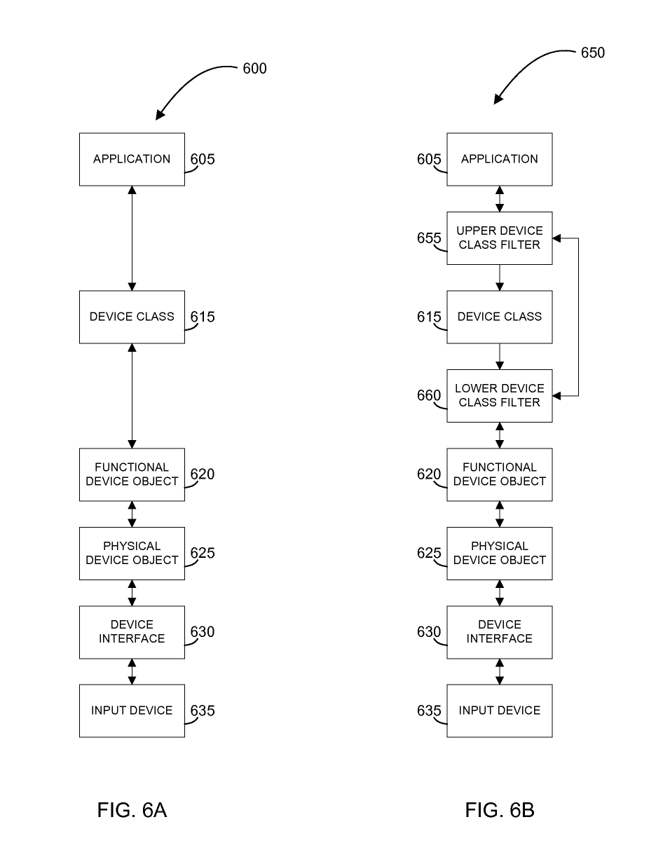

FIG. 3C shows the application view of the same configuration as might be stored by the operating system for use by applications. Generally applications do not need to be aware of the configuration of video cards and output connectors as the graphics driver interfaces are designed to abstract these details so the application 605 (seen in FIG. 6) only needs to know the number of video output devices supported and the names of the video output devices for use in addressing output to specific displays and to query the capabilities of the video card providing the output. In the Windows operating system this information is stored in the Windows Registry 350. FIG. 3C shows the representation of all the video cards (170a and 170b) and video outputs as a single set of video device names (360a-d) representing individual video outputs. The video device names are stored in this example under a key with a value of the identifier (340a and b) of the display devices (320a and b), with a value name corresponding to the video device identifier (350a-d) and a value content of the video device name (360a-d).

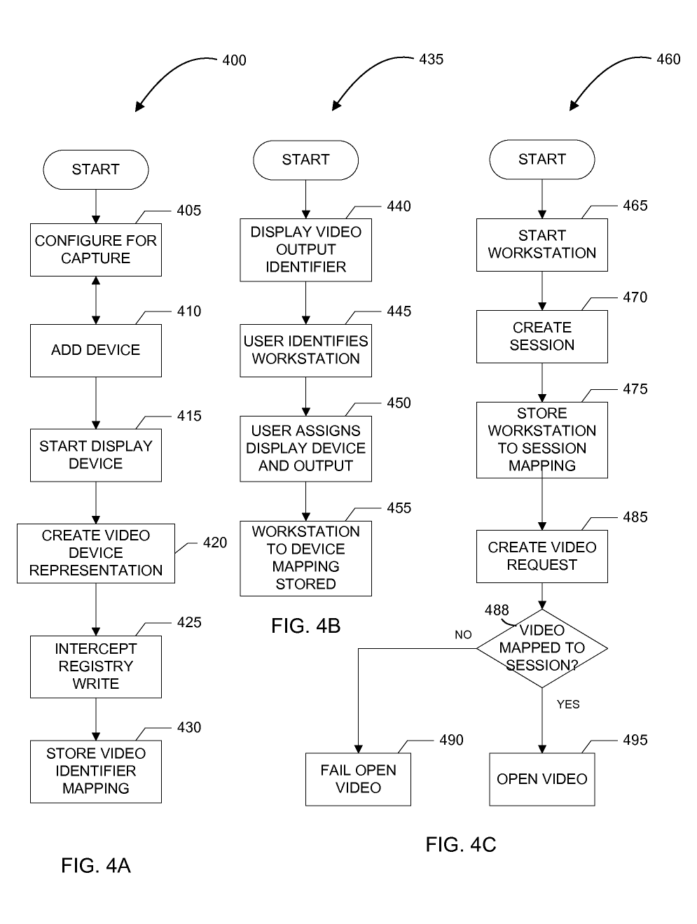

FIG. 4 show flow charts of the processes used in filtering video output devices.

FIG. 4A shows the flow chart 400 of steps done to register each video display device to create the application view of the video outputs.

FIG. 4B shows the flow chart 435 containing the steps taken to define an association between each video output assigned to a workstation.

FIG. 4C shows the flow chart 460 containing the steps taken when a workstation is started to filter the video output devices.

As shown in FIG. 4A a number of steps are taken when adding a video output device to the host computer. When this invention starts the video device stack is configured in step 405 to allow the capture of video information as described above. In the Windows operating system this would include the modification of the video device driver and graphics kernel interfaces to allow the capture of information normally passed by between these operating system components. After the operating system video components have been configured to allow the capture of video information, when each video device is added in step 410 the display device identifier (340a-d) passed as a parameter to the add device function is captured and when the display device is started in step (415) the number of outputs returned is captured, and when the operating system creates a representation of the video device in step 420 the name of the video device (360a-d) and the video device identifier (350a-d) are written to the Windows Registry 350 under the registry key with a value of the display device identifier (340a-d). The command to write this information to the registry is captured in step 425 and stored for use in associating display device identifiers, video device identifiers and video device names when processing video requests.

As stated above users normally associate video outputs with the display 120 on which the output appears and not the video card 170 or even the output connection or head 180 to which the display 120 is connected. This requires a method of allowing the user to identify each display 120 to create an association between the display 120 and the video card output connection 180 to which the display 120 is attached.

FIG. 4B schematically depicts a method 435 of associating displays to video outputs is to show a unique and recognizable image on the display 120 where the image is sent to a known video output. The user is then asked to identify the display 120 on which the recognizable image is shown. In the Windows operating system this is done when configuring the displays. The user interface for configuring displays shows an icon containing a digit for each connected video output. The user may request that the display 120 be identified at which time Windows overlays an image of the digit contained in the icon over the normal output shown on the video output allowing the user to determine which display icon in the user interface corresponds to which physical display 120 connected to the host computer.

An alternative to the Windows display configuration process for use in configuring

[symbol]

Once the video output identifier is shown in step 440 and the user has identified the workstation in step 445 the user can now assign the monitor to a workstation in step 450 by any of a number of means and the assignment or mapping is stored in step 455. The use of a keyboard input corresponding to a workstation number as described above is an optional method. Another optional method might be for the user to drag a representation of the identified monitor to a container holding representations of devices associated with the workstation in a drag and drop operation. In the final step the association between monitors and video output device name is stored for use in determining which video output devices are associated with each workstation.

FIG. 4C shows the sequence 460 of steps taken when starting a workstation to filter the video display devices assigned to the workstation. In this flow 460 the workstation is implemented using an operating system session 160 (for example as seen in FIG. 1) but any workstation implementation such as those described above may be used.

First the workstation is started in step 465. This may be done automatically when the host computer starts or manually when a user invokes the creation of a workstation. The next step (470) is to create the mechanism used to implement the workstation, in this example an operating system session 160. The identification of the created session 160 is then stored in step 475 to create an association between the persistent workstation identifier and the transient session identifier which may be different each time the workstation is created or changes the logged in user. If one of the methods based on the use of an application of creating a workstation is used the application identifier would be stored in place of the session identifier.

When the operating system generates a request to open a video output device in step 485 a determination 488 is made whether the video output device is associated with the workstation being started. This is may be done by retrieving the session identifier from the open request, using the association between the session identifier and the workstation identifier stored in step 475. The workstation identifier is then used to determine the association between the

[symbol]

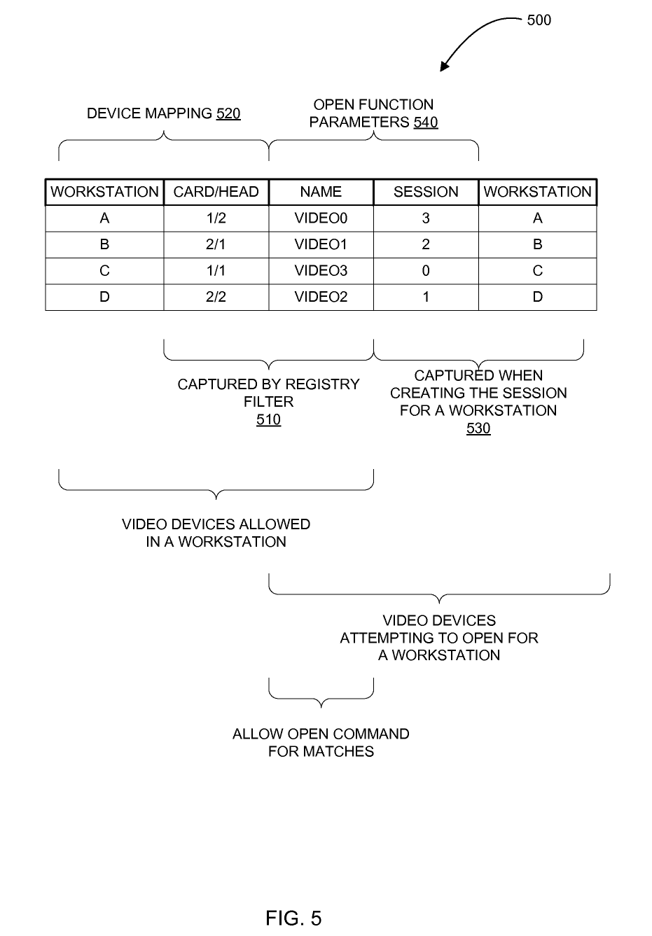

FIG. 5 schematically shows the data associations 500 used in mapping video devices with the sources of the associations. The first association is the association between the identifier used by the operating system to identify video output devices and the combination of the video card and output connection or head on the adapter (510). As stated above this association is captured when the operating system stores this information for internal use, such as in the Windows Registry in step 425 of FIG. 4A. The second association is the association between the workstation identifier and the video output device identifier (520) created when the user assigns video output devices to workstations as described above for step 450 in FIG. 4B. The final association is the association (530) between the workstation identifier shown for clarity at both ends of the table and the session identifier which is stored as described for Step 475 in FIG. 4C.

These associations allow for a matching between the specified video output devices assigned to each workstation and the session 160 used to implement the workstation. These two items (540) may be retrieved from the command used to open the video output device allowing a determination of the workstation known from the session identifier is allowed to use the video output device and therefore the monitor connected to the equivalent card and head combination.

These associations are not normally available from the operating system and are required to complete the association of an assigned display to the workstation to which the display 120 is assigned. Without this information the user would be required to identify and assign displays to workstations each time a workstation is created.

Buffered Input Devices

Buffered Input Devices are devices that receive user input and store the user input in a buffer until the input is requested by the operating system or an application 605. Examples or buffered input devices include for example keyboards and mice.

Buffered Input Devices may be filtered by providing filter drivers both above and

[symbol]

FIG. 6 show a representation of the original device stack 600 (FIG. 6A) and modified (FIG. 6B) device stack 650. The original device stack 600 provides processing of inputs from the physical input device 635, such as a keyboard 130 or mouse 140, represented at the bottom of the stack to the application 605 at the top of the stack. Input devices 635 such as keyboards (130a to d) and mice (140a to d) connect to the host computer using a device interface 630 implementing a protocol such as Universal Serial Bus (USB), PS/2, and Serial (RS232 standard). When a device is connected to the host computer the bus driver of the Windows operating system creates a Physical Device Object 625 to represent the physical state of the input device 635. A Functional Device Object 620 is created to create a generic interface to the input device 635 to provide commonality between input devices of a specific type such as a keyboard 130 or mouse 140 without reference to the specific device 635. A Device Class 615 is created by the device drivers to provide an interface to the Functional Device Object. In FIG. 6A the workstation is implemented using a Windows operating system Session 160 and applications 605 are executed within the Session 160.

The modified device stack shown in FIG. 6B shows the addition of the Upper Device Class Filter 655 and a Lower Device Class Filter 660 and the bypass communication provided by these filters around the Device Class 615.

The Upper Device Class Filter 655 accepts requests to connect sessions. In the Windows operating system such requests would be denied if a session 160 is connected to the Device Stack 615. The Upper Device Class Filter 655 enables use of the device stack by multiple sessions 160 implementing workstations (110a-d) by accepting the connection requests which would normally be denied.

The Lower Device Class Filter 660 is used to distribute inputs from input device 635 to a session executing in the different workstations (110a-d). The data structures used to hold the inputs from the input devices 635 are replicated for each workstation (110a-d) to allow the inputs

[symbol]

In some embodiments of this invention the normal operating system Device Class 615 is only used when the device stack 650 is initialized. Once the device stack is initialized all requests for input are queued in the Upper Device Class Filter 655. When input data is available Lower Device Class Filter replicates the data into queues of sessions that are associated with that device 655 for return to the requesting application 605.

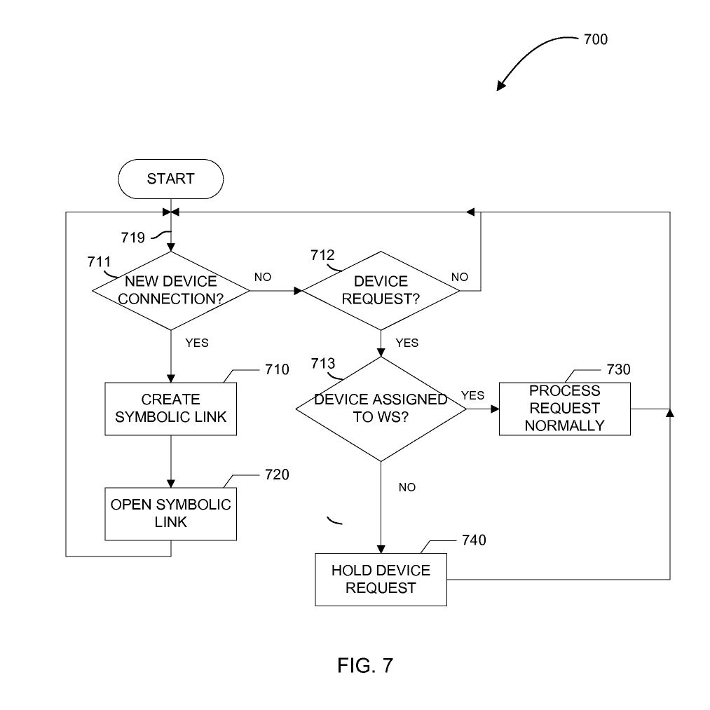

FIG. 7 presents a flow diagram 700 of a possible request handling for requests 719 sent to the modified device stack 650 for Buffered Input Devices when device filtering is implemented. When an input device 635 is connected to the host computer 105, the device connection is recognized 711 by the Device Interface 630 and a new connection process is initiated. In the Windows operating system this process is known as Plug and Play or PnP. The Upper 655 and Lower 660 Device Class Filters are created when the device stack 650 is created. An alternative symbolic link is created for each device stack.

When a device request is sent 719 from the session to the device, it is first processed by the Upper Device Class Filter 655. When a data request is received 712 by the Upper Device Class Filter 655 the Upper Device Class Filter 655 adds the request to a queue associated with the requesting workstation (e.g. 110a). When a command request is received the Upper Device Class Filter checks 713 whether the input device 635 is assigned to the requesting workstation (e.g. 110a). If the input device 635 is assigned to the requesting workstation (e.g. 110a) the request is processed normally. If the input device 635 is not assigned to the requesting workstation (e.g. 110a) the request is held in step 740 in the queue associated with the workstation (e.g. 110a) and is not returned to the requesting application 605.

Minifilter Devices

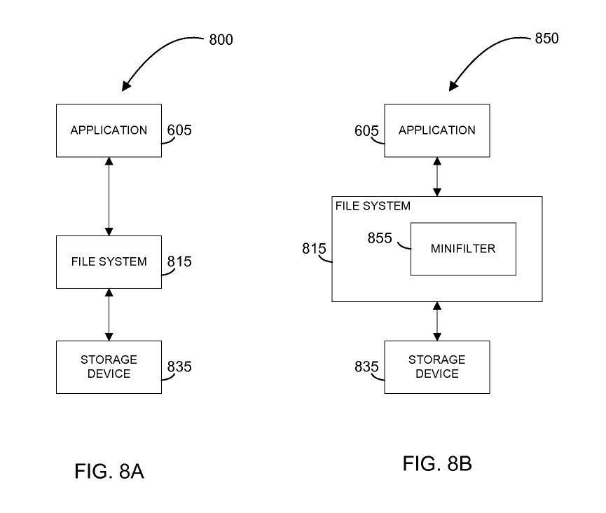

FIG. 8A schematically shows a representation of the original device stack 800.

FIG. 8B schematically shows a modified device stack 850 for storage devices 835.

The original device stack 800 provides processing of I/O requests to and from the physical storage device 835, such as a removable hard drive, Flash drive or Flash memory card, represented at the bottom of the stack to the application 605 at the top of the stack. When a storage device is connected to the host computer a File System is mounted on the storage device 835.

The modified device stack 850 shown in FIG. 8B shows the addition of a Minifilter 855

[symbol]

Minifilters 855 are special purpose drivers that can be inserted into the normal file system interface provided by the operating systems normal device stack. These are called minifilters since most such drivers are both special purpose and do very specific and minimal processing. For example, a minifilter might recognize when a file is written to schedule the modified file for backup, or recognize when a file is deleted to schedule the removal of the file from a mirror of the storage device. Normally minifilters are designed to do minimal processing to avoid reductions in performance since a single operation may need to be processed by multiple minifilters provided by different sources for unrelated purposes. For example, the writing of a file might need to be recognized by a backup application, an anti-virus application, and a performance monitoring application even before the data is written to the file.

Device for which a minifilter infrastructure exists may implement device filtering by providing a minifilter that either processes operations used to identify, initialize or open the device or associated data, and/or operations that provide commands to the device.

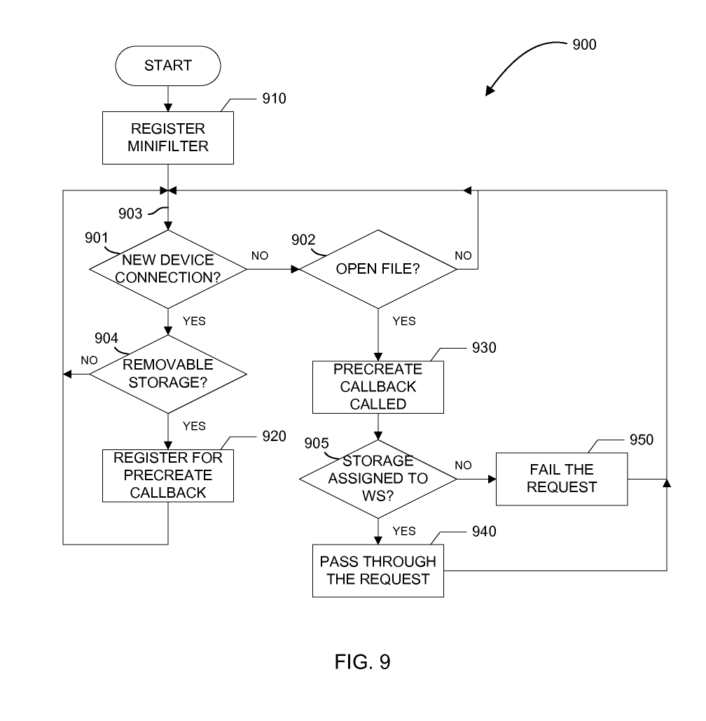

FIG. 9 schematically presents a flow diagram 900 of a possible command handling for commands to be sent to the modified device stack 850 for Storage Devices when device filtering is implemented. When this invention starts a minifilter is added to the file system interface in step 910. This minifilter is used to implement the rest of the processing shown in FIG. 9.

It may be more efficient to filter the device by processing commands that open the files on a device as usually a single such command is invoked for each file. For example, when filtering storage devices in the Windows operating system the Windows File System minifilter 885 facility may be used to add a minifilter in step 910 that processes new device connections and file open requests. If 901 a new device connection event is initiated a determination 904 can be made whether the device is removable storage. If the connected device is removable storage a registration is made to call the precreate callback function in step 920 by the minifilter registered in step 910. The precreate callback is a normal component of the Windows storage system. When the file system receives a file open request 902 the precreate callback function will be called in step 930. The precreate callback function determines 905 if the storage device 835 holding the file requested to be opened is assigned to the workstation (110a-d) associated with the session 160 in which the application 605 is running. If the storage device 835 is associated with the workstation (110a-d) the precreate callback function passes the open file request to the

[symbol]

Endpoint Devices

Devices, such as audio recording and playback devices, may be represented by endpoints. Endpoint device may be associated with workstations.

In this embodiment, the endpoints are filtered when a workstation (e.g. 110a) requests the list or enumeration of available endpoints. In the Windows operating system, normally endpoints are controlled by the Windows Multimedia Device (MMD) interface. Applications use the MMD interface to request a list of available endpoints. The MMD interface uses data stored in the Windows Registry to identify the known endpoints and to determine if the known endpoints are available. Known endpoints may be unavailable if the endpoint is disconnected, turned off.

This invention uses a process called registry filtering to filter the endpoints available to each workstation. When the MMD interface receives a request to enumerate the available endpoints for a workstation (e.g. 110a), it issues a number of standard registry operations to list the registry entries containing information specifying the known endpoints, and to retrieve data associated with the known endpoints.

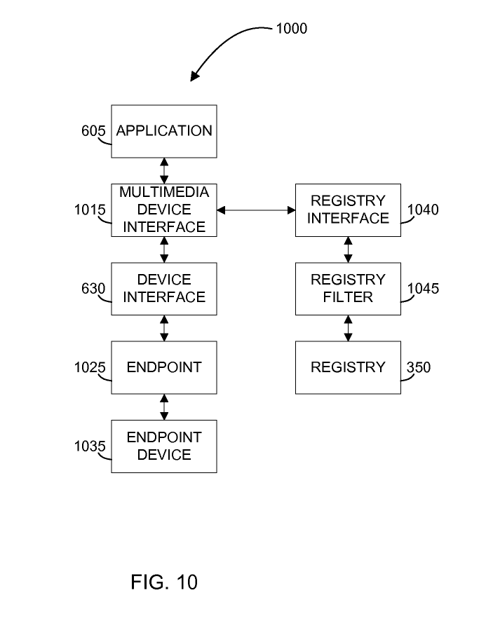

FIG. 10 shows a representation of the endpoint device stack 1000. The endpoint device stack 1000 provides processing of input/output (I/O) requests to and from the endpoint device 1035 represented at the bottom of the stack to the application 605 at the top of the stack. Endpoints 1025 are located on an Endpoint Device 1035 which is connected to the host computer using a device interface 630. In the Windows Operating System Endpoint Devices 1035 are synonymous with Audio input and/or output devices. When an endpoint device 1035 is connected to the host computer the device driver instantiates the endpoints 1025. A Multimedia Device Interface 1015 enumerates the endpoints 1025 to provide an interface to expose the Endpoints 1025 to the applications 605. Commands which are sent to the Multimedia Device Interface 1015, specifically the command to enumerate available endpoints, will read data from a data store such as the Windows Registry 350. In the Windows operating system, access to this data is through the Registry Interface 1040. This invention uses the capability of adding a

[symbol]

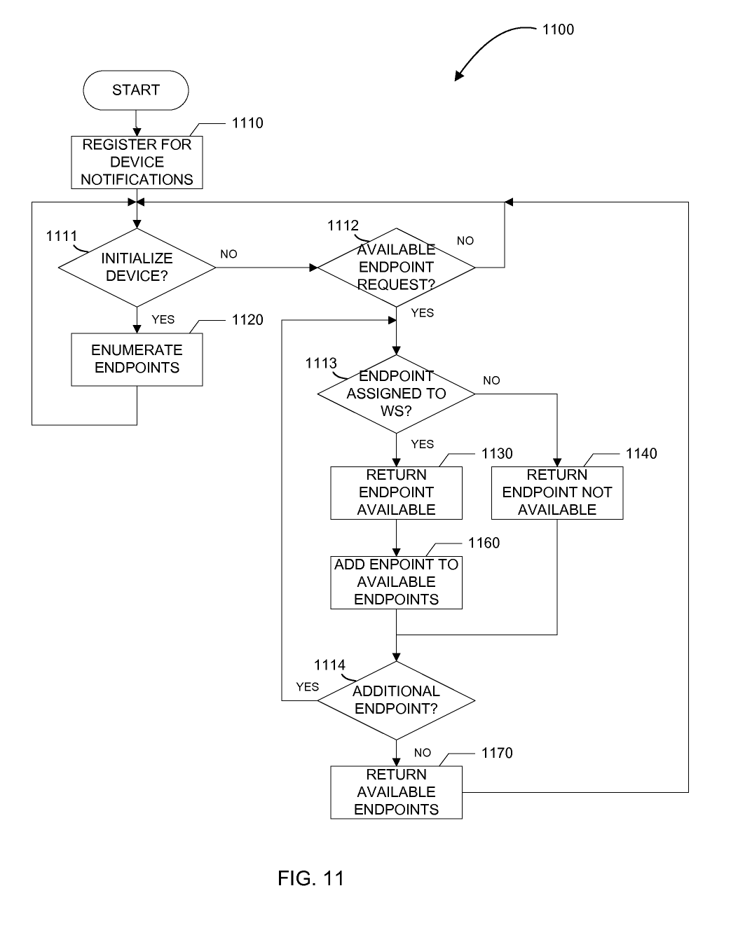

FIG. 11 presents a flow diagram 1100 of a possible command handling for commands sent to the endpoint device stack 1000 for endpoint Devices 1035. When an implementation of this invention is started it would register for device notifications 1045 in step 1110 to intercept these standard registry operations. The ability to register for device notifications is a standard component of the Windows operating system. When a command to initialize an endpoint device is received 1111 the endpoints of the device will be enumerated by the Multimedia Device Interface 1050. The registry filter 1045 created when this invention begins receives the standard registry operations and processes each request to capture the data written to the registry as each endpoint is enumerated.

When an application 605 requires the use of an endpoint device a list of available endpoints will be requested. When this request is received 1112 by the Multimedia Device Interface 1035 it will request the availability of each endpoint as stored in the registry 350. As each registry read request is made it is captured by the registry filter 1045. The registry filter determines 1113 if the device associated with the endpoint is assigned to the workstation requesting the list of available endpoints. Determination of the device association is equivalent to determination of association of the endpoint to the workstation (e.g. 110a) since endpoints represent capabilities of individual devices so assignment of an endpoint device 1035 is equivalent to assignment of all endpoints 1025 of the endpoint device 1035 to the workstation (e.g. 110a). If the endpoint 1025 is assigned to the workstation (e.g. 110a) it is returned in step as available to the Multimedia Device Interface 1035 and added by the Multimedia Device Interface 1035 in step 1160 to the list of available endpoints. If the device 1015 associated with the endpoint 1025 is not assigned to the workstation (e.g. 110a) requesting the list of available endpoints the registry filter modifies the data read from the registry to indicate that the endpoint 1025 is not available and returns the modified data in step 1140 to indicate to the Multimedia Device Interface 1015 that the endpoint is not available resulting in the endpoint not being added to the list of available endpoints by the Multimedia Device Interface 1015. The Multimedia Device Interface 1015 repeats the request for endpoint data from the registry as long as 1114 there are additional endpoints. When all endpoints have been checked for availability the Multimedia Device Interface 1015 returns the list of available endpoints to the requesting

[symbol]

Unbuffered Input Devices

Unbuffered Input Devices such as video inputs devices including cameras and scanners may be filtered by adding a filter driver to filter access requests to the devices. In the Windows operating system this may be done by creating a Filter Driver 1255 above the Kernel Interface 1230. When the Filter Driver receives a request to create a link to the unbuffered input device 1235 it identifies the session 160 of the invoking application 605. If the session 160 is associated with a workstation and the device is not assigned to the workstation the filter driver returns a result indicating that access is denied to the device, otherwise the command is processed as normal. Also, if the command is not a request to access the device the command is processed as normal.

Unbuffered Input Devices may be processed more simply than Buffered Input Devices as a separate buffer is not required for each workstation. This also allows the assignment of Unbuffered Input devices to multiple workstations.

Where the Unbuffered Input Device 1235 has other command structures above the device stack used to open, initialize or create an interface to the device it may also be possible to filter the request to open, initialize or create an interface to filter access to the device. For example, in the Windows operating system it is possible to create a filter to reject access requests from the Direct Show or Video for Windows interfaces.

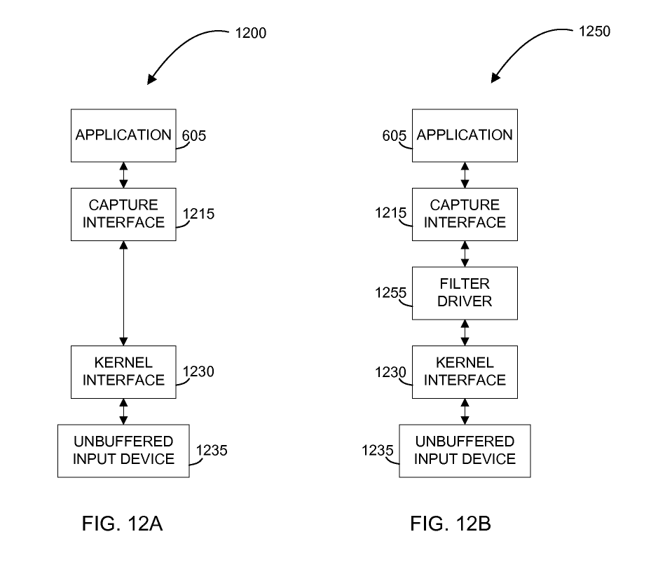

FIG. 12A schematically shows a representation of the original unbuffered device stack 1200.

FIG. 12B schematically shows a representation of a modified unbuffered device stack 1250.

The original unbuffered device stack 1200 provides processing of inputs from the physical unbuffered input device 1235, such as a video camera, represented at the bottom of the stack to the application 605 at the top of the stack. Unbuffered input devices 1235 such as video cameras connect to the host computer using a Kernel Interface 1230 implementing a protocol such as Universal Serial Bus (USB), composite video, or FireWire. A Capture Interface 1215 is created by the operating system to provide an interface from the application 605 to the Kernel

[symbol]

The modified unbuffered device stack 1250 shown in FIG. 12B shows the addition of a Filter Driver 1255 for processing of unbuffered device commands.

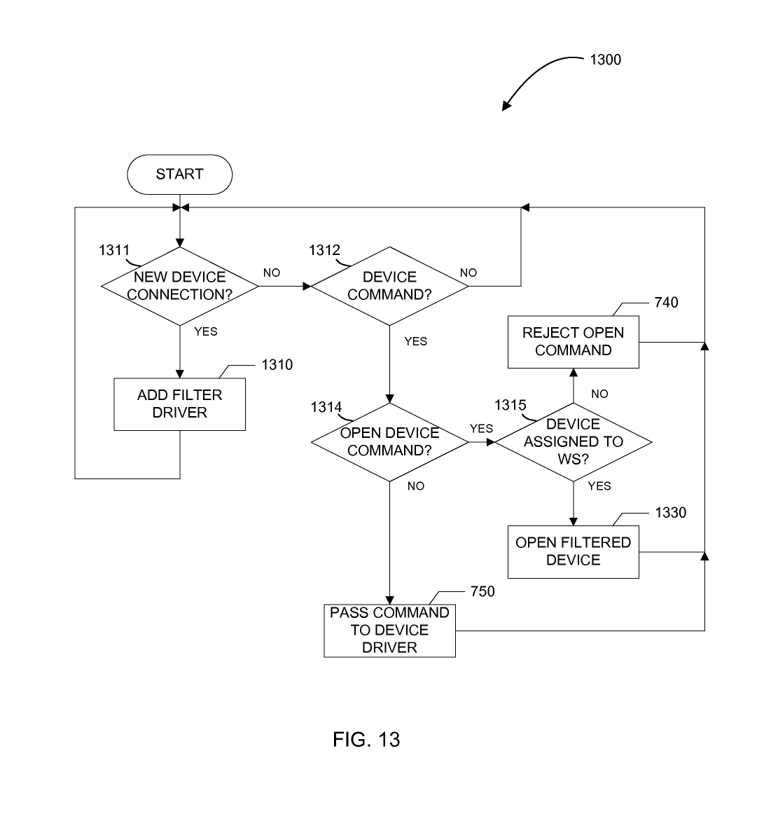

FIG. 13 presents a flow diagram 1300 of a possible command handling for commands sent to the modified device stack 1250 for unbuffered Input Devices when device filtering is implemented. When an unbuffered input device 1235 is connected to the host computer 105, the device connection is recognized 1311 by the Device Interface 630 and a new connection process is initiated. In the Windows operating system this process is known as Plug and Play or PnP. After the device stack 650 for the device is created each session 160 creates a filter driver 1255 bellow the Capture Interface 1215 in Step 1310 for use in accessing the device.

When a command 1311 is sent to the device it is processed by the Filter Driver 1255. The Filter Driver 1255 checks 1314 whether the command is a request to open a device and if it is not an open command it passes the command to the Kernel Interface 1230 for normal processing in step 750. If the command is a request to open an unbuffered device an additional test 1315 is made to determine if the unbuffered device is assigned to the workstation. The workstation is identified in this embodiment by the session 160 that sent the request to the device stack 1250. The session 160 is associated with a workstation (110a to d) when the workstation session 160 is created as described above. If the device is assigned to a workstation and the workstation initiating the open request is not the workstation to which the device is assigned the command is suspended in step 740 and does not return a result. If the device is assigned to a workstation and the workstation initiating the open request is the workstation to which the device is assigned the command is passed to the Kernel Interface 1230 for normal processing in step 1330.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

[The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the

[symbol]

Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of limiting device operations to workstations associated with operating system sessions comprising:
assigning a device to a workstation; and
using a filter to allow access to only assigned devices from specified workstations.

2. The method of claim 1, and mapping from operating system sessions to video output devices.

3. The method of claim 2, and mapping from video device names to video output identifiers.

4. The method of claim 1, and filtering device commands to buffered input devices.

5. The method of claim 4, wherein said filtering device commands comprises using of an upper and lower filter driver.

6. The method of claim 5, wherein said upper filter driver allows connecting multiple sessions to the device stack.

7. The method of claim 5, wherein said lower filter driver provides separation of received inputs into separate queues for each workstation.

8. The method of claim 5, wherein said filtering device commands allows for bypassing of device stack components by communicating commands directly between the upper and lower filter drivers.

9. The method of claim 1, and comprising filtering removable storage.

10. The method of claim 9, wherein said filtering is based on using minifilters.

11. The method of claim 10, wherein said filtering comprises using minifilters filters access to removable storage by accepting or rejecting requests to open at least one of: the volumes; and files on the removable storage.

12. The method of claim 1 and comprising filtering unbuffered input devices.

13. The method of claim 12, wherein said filtering comprising using filter drivers.

14. The method of claim 13, wherein said filter drivers filter access to unbuffered input devices by accepting or rejecting commands to open said unbuffered input devices.

15. The method of claim 1, and comprising filtering endpoint devices.

16. The method of claim 15, wherein said filtering is based on the using of registry filters.

17. The method of claim 13, wherein said registry filters filter access to the endpoint devices by modifying the reported availability of endpoints.
